(19) United States
(12) Patent Application Publication
(10) Pub. No.: US 2014/0309988 A1
(43) Pub. Date: Oct. 16, 2014

(54) CPW method with application in an application system

(71) Applicant: Bernd Schneider, Ihringen (DE)

(72) Inventor: Bernd Schneider, Ihringen (DE)

(21) Appl. No.: 13/986,242

(22) Filed: Apr. 15, 2013

(51) Int. Cl. G06Q 10/06; G06F 17/28

(52) U.S. Cl. CPC G06Q 10/06; G06F 17/28
USPC 704/9; 703/6

(57) ABSTRACT

The Cognitive Process Workflow (CPW) method with its grammar, syntax and semantics is a process method, a process modeling method and a workflow method applicable to different technical systems. Among others also the application of the CPW Method in a process tool, workflow tool, workflow engine, enterprise architecture framework and enterprise architecture engine. The CPW Process is represented as simple sentence with a CPW Subject, a CPW Predicate and a CPW Object. The CPW Method—with CPW Process, CPW Dialog and CPW Workflow and in addition with CPW Context Diagrams (CPW Subject Context Diagram, CPW Object Context Diagram and CPW Subject Object Context Diagram)—can be applied to the business areas of financial services (banking, assurance and financial approval), chemistry, pharmacy, medicine, transport, travel, film industry, politics, psychology, legal practice and other business areas.

This application is a continuation-in-part of U.S. application Ser. No. 10/486,290, which is the National Stage of International Application No. PCT/IB01/01337, filed Jul. 26, 2001, and also a continuation-in-part of U.S. application Ser. No. 12/312,671, which is a continuation of International Application No. PCT/IB2006/003133, filed Nov. 7, 2006, and the U.S. application Ser. No. 12/312,671, which is a continuation of International Application No. PCT/IB2006/003133, filed Nov. 7, 2006, is a continuation-in-part of U.S. application Ser. No. 10/486,290, which is the National Stage of International Application No. PCT/IB01/01337, filed Jul. 26, 2001.

### 1 BACKGROUND OF THE INVENTION

1. Technical Field

The invention relates to a new and improved process method, process modeling method and workflow method applicable in process tools and workflow tools, workflow engine, Enterprise Architecture Framework, Enterprise Architecture Engine, and other application systems or technical systems. The invention relates to a new and improved process method, a process modeling method and a workflow method, which can be also applied in combination with context diagrams.

2. Description of the Prior Art

Other process methods, process modeling methods and workflow methods do not have the representation of a process step as a simple sentence with a Subject, a Predicate and a Object.

Other conventional process methods, process modeling methods and workflow methods (e.g. OMG OMG Unified Modeling Language Specification (UML), Business Process Modeling Language (BPML)) have in general only one bubble for a process step. In many cases the subject is missing in the bubble of the represented process step or workflow step. In many cases in the bubble a complete sentence is not represented, but only a part of the sentence. This is the reason, that the process steps with the conventional process methods are sometimes difficult to read and to understand.

### 2 BRIEF SUMMARY OF THE INVENTION

With CPW Process every process step is a simple sentence with a CPW Subject, a CPW Predicate and a CPW Object.

At every process step of a CPW Process with a CPW Subject, a CPW Predicate and a CPW Object, represented as simple sentence, the CPW Subject is assigned to a responsibility.

At every process step of a CPW Process with a CPW Subject, a CPW Predicate and a CPW Object, represented as simple sentence, the CPW Object is assigned to a process result.

The reason is, why every process step with the CPW Process is represented as a simple Sentence with a CPW Subject, a CPW Predicate and a CPW Object, that the CPW Process as process is thereby more readable, clearer and more transparent than other methods or process methods, process modeling methods and workflow methods.

The CPW Process can be applied in combination with CPW Context Diagrams, CPW Subject Context Diagram, CPW Object Context Diagram and CPW Subject Object Context Diagram.

That a process step with CPW Process can be represented as a simple sentence with a CPW Subject, a CPW Predicate and a CPW Object, makes it possible to apply the Processes in combination with CPW Context Diagrams. This means, that the CPW Subjects and CPW Objects, which are used in the particular process steps of the CPW Processes, are represented in the CPW Context Diagrams with CPW Subjects and CPW Objects.

This feature, that the CPW Process can be applied in combination with CPW Context Diagrams, CPW Subject Context Diagram, CPW Object Context Diagram and CPW Subject Object Context Diagram, makes the CPW Method much clearer and more transparent than other methods or process methods, process modeling methods and workflow methods.

Summary of key criteria to compare the CPW Method with other process methods, process modeling methods and workflow methods:

Does another process method, a process modeling method and a workflow method exist, where every process step is represented as a sentence with a subject, a predicate and a object?

Does another process method, a process modeling method and a workflow method exist, with which it is possible, that every process step is represented as a sentence with a subject, a predicate and a object and in addition the subjects and objects, which are used in the particular process steps, are used in context diagrams with subjects and objects?

Do other Enterprise Architecture Frameworks, Enterprise Architecture Engines, and other application systems or technical systems have the new and improved methods and possibilities, which are described in this patent application?

Furthermore the CPW Method comprise with their extensions among others the application of the CPW Method in a CPW Enterprise Architecture Framework and a CPW Enterprise Architecture Engine.

### 3 SUMMARY OF THE PATENT APPLICATION OR OF THE INVENTION

The Cognitive Process Workflow (CPW) method with its grammar, syntax and semantics is a process method, a process modeling method and a workflow method applicable to different technical systems. Among others also the application of the CPW Method in a process tool, workflow tool, workflow engine, enterprise architecture framework and enterprise architecture engine. The CPW Process is represented as simple sentence with a CPW Subject, a CPW Predicate and a CPW Object. The CPW Method—with CPW Process, CPW Dialog and CPW Workflow and in addition with CPW Context Diagrams (CPW Subject Context Diagram, CPW Object Context Diagram and CPW Subject Object Context Diagram)—can be applied to the business areas of financial services (banking, assurance and financial approval), chemistry, pharmacy, medicine, transport, travel, film industry, politics, psychology, legal practice and other business areas.

### 4 BRIEF DESCRIPTION OF THE SEVERAL VIEWS OF THE DRAWING(S)

FIG. 1 shows the graphically represented CPW Process as Simple Sentence with a CPW Subject 101, a CPW Predicate 102 and a CPW Object 103.

FIG. 2 shows the graphically represented CPW Processes in a CPW Dialog.

FIG. 3 shows an example of a graphically represented CPW Workflow—how IT Projects can be realized.

FIG. 4 shows a CPW Subject Context Diagram, which consists exclusively of CPW Subjects.

FIG. 5 shows a CPW Object Context Diagram, which consists exclusively of CPW Objects.

FIG. 6 shows a CPW Subject Object Context Diagram, which consists exclusively of CPW Subjects and CPW Objects.

In FIG. 7 is represented in a diagram, on which different Levels and in which diverse areas the CPW Method can be applied in business and IT.

### 5 DETAILED DESCRIPTION OF THE INVENTION OR THE APPLIED APPLICATION

In the following chapters is described the detailed description of the Cognitive Process Workflow (CPW) Method with their extensions.

### 6 FIRST APPLICATION

### The CPW Process

The following list of rules shows the rules for the Grammar, Syntax and Semantics of the CPW Process of the International Application No. PCT/IB01/01337, filed Jul. 26, 2001, of the U.S. application Ser. No. 10/486,290, filed Aug. 20, 2004.

| No. | Grammar, Syntax and Semantics of the CPW Process. |
|---|---|
| 1 | The CPW Process is represented as Simple Sentence with |
| | subject 101, predicate 102 and object 103. |
| 2 | The CPW Process in the form of a Simple Sentence consists of the |
| | following phrases: |
| | Subject 101: Description of the subject (person, organizational unit |
| | or thing) |
| | Predicate 102: Description of the process (verb in the infinitive or |
| | conjugated) |
| | Object 103: Description of the object (sentence complement). |
| 3 | The CPW Process in the form of a sentence can be formed |
| | actively 106 or passively 107. |
| 4 | According to the CPW definition the process in the conventional |
| | sense is a predicate. |
| | From now on the conventional process (predicate) 102 is |
| | consequently put in the context of a responsibility (subject). |
| | 101 and a process result (object) 103, thus forming a |
| | CPW Process. |

### The CPW Dialog and the CPW Workflow

The following list of rules shows the rules for the Grammar, Syntax and Semantics of the CPW Dialog and of the CPW Workflow of the International Application No. PCT/IB01/01337, filed Jul. 26, 2001, of the U.S. application Ser. No. 10/486,290, filed Aug. 20, 2004.

| | Grammar, Syntax and Semantics of the CPW Dialog and of the |
|---|---|
| No. | CPW Workflow |
| 1 | The CPW Dialog consists of several Simple Sentences |
| | respectively CPW Processes which are linked to one another 202. |
| 2 | Several sentences respectively CPW Processes can be linked |
| | sequentially 202, logically 204, iteratively 206 or parallely 204 to |
| | a CPW Dialog. |
| 3 | The Complexity of a business area can be distributed on several |
| | CPW Dialogs. |
| 4 | A CPW Workflow consists of at least one CPW Dialog. |

### The Graphical Representation of the CPW Process

The following list of rules shows the rules for the Grammar, Syntax and Semantics for the graphical representation of the CPW Process of the International Application No. PCT/IB01/01337, filed Jul. 26, 2001, of the U.S. application Ser. No. 10/486,290, filed Aug. 20, 2004.

| | Grammar, Syntax and Semantics for the graphical representation |
|---|---|
| No. | of the CPW Process |
| 1 | The CPW Process is graphically represented in the form of a |
| | Simple Sentence with subject 101, predicate 102 and object 103. |
| 2 | Within a represented CPW Process respectively within a sentence |
| | the subject 101, predicate 102 and object 103 each corresponds |
| | with a graphic object. |
| 3 | Subject 101, predicate 102 and object 103 - each represented |
| | as a single graphic object - are graphically linked to one another |
| | with arrows (arrow 104 and arrow 105) so that they form a |
| | Simple Sentence. |

### The Graphical Representation of the CPW Dialog Respectively of the CPW Workflow

The following list of rules shows the rules for the Grammar, Syntax and Semantics for the graphical representation of the CPW Dialog and of the CPW Workflow of the International Application No. PCT/IB01/01337, filed Jul. 26, 2001, of the U.S. application Ser. No. 10/486,290, filed Aug. 20, 2004.

| | Grammar, Syntax and Semantics for the graphical representation |
|---|---|
| No. | of the CPW Dialog and of the CPW Workflow. |
| 1 | Several CPW Processes linked to one another 202 form a CPW |
| | Dialog or a CPW Workflow. |
| 2 | The CPW Processes can be linked sequentially 202 to a CPW |
| | Dialog or a CPW Workflow. |
| 3 | After a CPW Process there can be a logical operation 204 due to a |
| | decision within a CPW Dialog or CPW Workflow. |
| 4 | Within a CPW Dialog or CPW Workflow there can be |
| | an iteration 206. |
| 5 | Within a CPW Dialog or CPW Workflow a CPW Process can |
| | be followed by one respectively several CPW Processes |
| | parallelly 204. |
| 6 | The complexity of a business area can be distributed on several |
| | CPW Dialogs. |
| 7 | A CPW Workflow consists of at least one CPW Dialog. |

### CPW Context Diagrams

### CPW Subject Context Diagram

The following list of rules shows the rules for the Grammar, Syntax and Semantics of the CPW Subject Context Diagram of the International Application No. PCT/IB01/01337, filed Jul. 26, 2001, of the U.S. application Ser. No. 10/486,290, filed Aug. 20, 2004.

| | Grammar, Syntax and Semantics of the CPW Subject |
|---|---|
| No. | Context Diagram |
| 1 | Within a CPW Workflow each subject 101 is represented |
| | as graphic object. |
| 2 | Within a CPW Subject Context Diagram all subjects 101 are |
| | graphically linked to one another given the fact that a connection |
| | between the respective subjects exists respectively makes sense. |
| 3 | Several subjects can be linked to one another by creating a |
| | new abstract Subject 101. Thereby a hierarchy between the subjects |
| | can come into place. |

### CPW Object Context Diagram

The following list of rules shows the rules for the Grammar, Syntax and Semantics of the CPW Object Context Diagram of the International Application No. PCT/IB01/01337, filed Jul. 26, 2001, of the U.S. application Ser. No. 10/486,290, filed Aug. 20, 2004.

| | Grammar, Syntax and Semantics of the CPW Object |
|---|---|
| No. | Context Diagram |
| 1 | Within a CPW Workflow each object 103 is represented as |
| | graphical object. |
| 2 | Within a CPW Object Context Diagram all objects 103 are |
| | graphically linked to one another given the fact that a connection |
| | between the respective objects exists respectively makes sense. |
| 3 | Several objects can be linked to one another by creating a new |
| | abstract object. Thereby a hierarchy between the objects can come |
| | into place. |

### CPW Subject Object Context Diagram

The following list of rules shows the rules for the Grammar, Syntax and Semantics of the CPW Subject Object Context Diagram of the International Application No. PCT/IB01/01337, filed Jul. 26, 2001, of the U.S. application Ser. No. 10/486,290, filed Aug. 20, 2004.

| | Grammar, Syntax and Semantics of the CPW Subject Object |
|---|---|
| No. | Context Diagram |
| 1 | Within a CPW Workflow each subject 101 and object 103 is |
| | represented as graphical Object. |
| 2 | Within a CPW Subject Object Context Diagram all subjects 101 |
| | and objects 103 are graphically linked to one another given the fact |
| | that a connection between the respective objects exists respectively |
| | makes sense. |
| 3 | Several subjects and objects can be linked to one another by |
| | creating a new abstract object. Thereby a hierarchy between the |
| | subjects and objects can come into place. |

### 7 SECOND APPLICATION

### Method Extensions of the CPW Process

The following list of rules shows the rules for the Grammar, Syntax and Semantics extensions of the CPW Process of the International Application No. PCT/IB2006/003133, filed Nov. 7, 2006, of the U.S. application Ser. No. 12/312,671, filed May 16, 2009.

| No. | Grammar, Syntax and Semantics extensions of the CPW Process |
|---|---|
| 1 | The CPW Process is represented in the application |
| | PCT/IB01/01337 as Simple Sentence with subject, predicate |
| | and object. |
| 2 | Subject, Predicate and Object of the CPW Process can also |
| | be named as CPW Subject, CPW Predicate and CPW Object. |
| 3 | The CPW Process defined in the application PCT/IB01/01337 |
| | is in this application a CPW Process Step, so that the CPW Process |
| | can consists of one or more CPW Process Steps. |
| 4 | The CPW Workflow can consequently also consists of one or |
| | more CPW Process Steps. |

### Method Extensions of the CPW Dialog

The following list of rules shows the rules for the Grammar, Syntax and Semantics extensions of the CPW Dialog of the International Application No. PCT/IB2006/003133, filed Nov. 7, 2006, of the U.S. application Ser. No. 12/312,671, filed May 16, 2009.

| No. | Grammar, Syntax and Semantics extensions of the CPW Dialog |
|---|---|
| 1 | In the application PCT/IB01/01337 the CPW Dialog has |
| | been introduced. |
| | The CPW Dialog can be interpreted as Dialog as follows: |
| | Business Dialog |
| | System Dialog |
| | Technical Dialog |
| | Dialog between Systems |
| | Dialog from machine to machine |
| | Dialog from system to system |
| | Conversation dialog between people |
| | Conversation dialog between people with interaction to system or |
| | machine |
| | Dialog between people and environment |
| | Business Process Dialog |
| | Business System Dialog |
| | Dialog in a Business Process |
| | Dialog between man and machine or system |
| | Dialog between people |
| | Dialog between man and Business System |
| | Sociocultural dialog between people |
| | Sociocultural dialog between people and systems |
| 2 | The CPW Dialog can consists of one or more CPW Process Steps. |
| 3 | The CPW Dialog can consists of one or more CPW Processes. |
| 4 | The CPW Dialog can consists of one or more CPW Workflows. |
| 5 | The CPW Dialog can contains one or more CPW Processes. |
| 6 | The CPW Dialog can contains one or more CPW Workflows. |
| 7 | The CPW Process can contains one or more CPW Dialogs. |
| 8 | The CPW Workflow can contains one or more CPW Dialogs. |
| 9 | Is the CPW Subject of the CPW Process Step of the CPW Dialog a |
| | person, or a speaking system, so the CPW Process Step with CPW |
| | Subject, CPW Predicate and CPW Object can contains the Direct |
| | Speech or Reported Speech of the dialog, it is the CPW Dialog |
| | with Direct Speech or the CPW Dialog with Reported Speech. |
| | The CPW Predicate in this case corresponds to a verb like for |
| | example: to say, to mean, to shout, to scream, to speak . . . |

### 8 THIRD APPLICATION

The invention refers to a new and improved process method, a process modeling method and a workflow method, which can be also applied in combination with Context Diagrams.

The method has been created by Bernd Jakob Schneider and is called Cognitive Process Workflow (CPW) Method.

The Cognitive Process Workflow (CPW) Method is subdivided into:
1. CPW Process
2. CPW Dialog
3. CPW Workflow
4. CPW Context Diagrams

The CPW Context Diagrams are subdivided into:
4.1. CPW Subject Context Diagram
4.2. CPW Object Context Diagram
4.3. CPW Subject Object Context Diagram

The CPW Method is with the CPW Process, the CPW Dialog and the CPW Workflow a process method, a process modeling method and a workflow method and in addition belong to the CPW Method the CPW Context Diagrams with the CPW Subject Context Diagram, the CPW Object Context Diagram and the CPW Subject Object Context Diagram.

The Cognitive Process Workflow (CPW) Method can be applied in all kinds of applications in technical systems and comprises:
1. The application of the CPW Method in a Workflow Engine and a Workflow Tool.
2. The application of the graphical representation of the CPW Method in a technical system.
3. The application of the CPW Method in an application system with integrated database.
4. The application of the CPW Method in a Process Tool.
5. The application of the CPW Method in a business tool, IT Tool, IT Development Tool, IT System.
6. The application of the CPW Method by means of Internet technologies.
7. The application of the CPW Method in an application system.
8. The CPW Method can be applied in different business areas.
9. The application of the CPW Method in an Enterprise Architecture Framework and an Enterprise Architecture Engine.
10. The application of the CPW Method in a CPW Enterprise Architecture Framework and a CPW Enterprise Architecture Engine.
11. The application of the CPW Method by means of XML, XML Process Definition Language (XPDL), Web Services (WS), Business Process Modeling Notation (BPMN), Business Process Execution Language (BPEL), Web Services Definition Language (WSDL), Flow Definition Language (FDL) and other technical methods and protocols.

The CPW Method can be applied to the following various business areas:
1. Financial Services (Banking, insurance industry and Financial Accounting and Auditing),
2. Chemistry, Pharmacy,
3. Medicine,
4. Transportation and shipping, Travel,
5. Film industry,
6. Politics,
7. Psychology,
8. Legal Practice, Jurisprudence, Judiciary and other business areas.

### The CPW Process

The following list of rules shows the rules for the Grammar, Syntax and Semantics of the CPW Process of the International Application No. PCT/IB01/01337, filed Jul. 26, 2001, of the U.S. application Ser. No. 10/486,290, filed Aug. 20, 2004, and their extensions of the CPW Process of the International Application No. PCT/IB2006/003133, filed Nov. 7, 2006, of the U.S. application Ser. No. 12/312,671, filed May 16, 2009 and the following list of rules shows the rules for the Grammar, Syntax and Semantics of the extensions of the CPW Process according to the third and the present application.

| No. | Grammar, Syntax and Semantics of the CPW Process |
|---|---|
| 1 | The CPW Process is represented as Simple Sentence with a |
| | CPW Subject 101, a CPW Predicate 102 and a CPW Object 103. |
| 2 | The CPW Process as Simple Sentence consists of the following |
| | phrases: A CPW Subject 101: Description of the subject (person, |
| | organizational unit or thing) |
| | A CPW Predicate 102: Description of the process (verb in the |
| | infinitive or conjugated) |
| | A CPW Object 103: Description of the Object (a CPW Sentence |
| | Complement and a CPW Object Extension). |
| 3 | The CPW Process as sentence can be formed actively 106 or |
| | passively 107. |
| 4 | According to the CPW Definition the process in the conventional |
| | sense is a CPW Predicate. |
| | From now on the conventional process (CPW Predicate) 102 is |
| | consequently put in the context of a responsibility (a CPW Subject) |
| | 101 and a process result (a CPW Object) 103, thus forming a |
| | CPW Process. |

### The CPW Process, CPW Dialog and the CPW Workflow

The following list of rules shows the rules for the Grammar, Syntax and Semantics of the CPW Process, of the CPW Dialog and of the CPW Workflow of the International Application No. PCT/IB01/01337, filed Jul. 26, 2001, of the U.S. application Ser. No. 10/486,290, filed Aug. 20, 2004.

| | Grammar, Syntax and Semantics of the CPW Process, of the |
|---|---|
| No. | CPW Dialog and of the CPW Workflow |
| 1 | The CPW Dialog consists of several Simple Sentences |
| | respectively CPW Processes which are linked to one another 202. |
| 2 | Several sentences respectively CPW Processes can be linked |
| | sequentially 202, logically 204, iteratively 206 or parallely 204 to |
| | a CPW Dialog. |
| 3 | The Complexity of a business area can be distributed on several |
| | CPW Dialogs. |
| 4 | A CPW Workflow consists of at least one CPW Dialog. |

### The Graphical Representation of the CPW Process

The following list of rules shows the rules for the Grammar, Syntax and Semantics for the graphical representation of the CPW Process of the International Application No. PCT/IB01/01337, filed Jul. 26, 2001, of the U.S. application Ser. No. 10/486,290, filed Aug. 20, 2004.

| | Grammar, Syntax and Semantics for the graphical representation of |
|---|---|
| No. | the CPW Process |
| 1 | The CPW Process is graphically represented as Simple Sentence |
| | with a CPW Subject 101, a CPW Predicate 102 and a CPW Object |
| | 103. |
| 2 | Within a represented CPW Process respectively within a sentence |
| | the CPW Subject 101, the CPW Predicate 102 and the CPW Object |
| | 103 each corresponds with a graphic object. |
| 3 | The CPW Subject 101, the CPW Predicate 102 and the CPW |
| | Object 103 - each represented as a single graphic object - are |
| | graphically linked to one another with arrows (arrow 104 and |
| | arrow 105) so that they form a Simple Sentence respectively a |
| | CPW Process. |

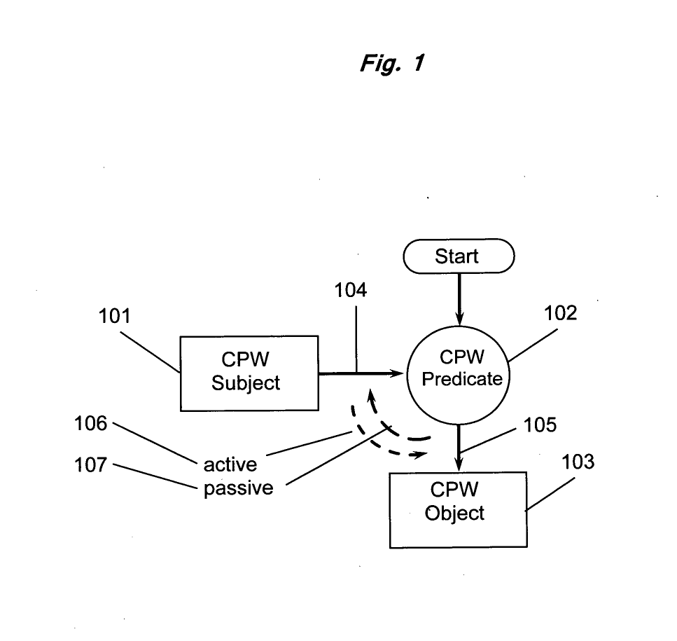

FIG. 1 shows the graphically represented CPW Process as Simple Sentence with a CPW Subject 101, a CPW Predicate 102 and a CPW Object 103.

### the Graphical Representation of the CPW Process, of the CPW Dialog Respectively of the CPW Workflow

The following list of rules shows the rules for the Grammar, Syntax and Semantics for the graphical representation of the CPW Process, of the CPW Dialog and of the CPW Workflow of the International Application No. PCT/IB01/01337, filed Jul. 26, 2001, of the U.S. application Ser. No. 10/486,290, filed Aug. 20, 2004.

| | Grammar, Syntax and Semantics for the graphical representation of |
|---|---|
| No. | the CPW Process, of the CPW Dialog and of the CPW Workflow |
| 1 | Several CPW Processes linked to one another 202 form a CPW |
| | Dialog or a CPW Workflow. |
| 2 | The CPW Processes can be linked sequentially 202 to a CPW |
| | Dialog or a CPW Workflow. |
| 3 | After a CPW Process there can be a logical operation 204 due to |
| | a decision within a CPW Dialog or CPW Workflow. |
| 4 | Within a CPW Dialog or CPW Workflow there can be an iteration |
| | 206. |
| 5 | Within a CPW Dialog or CPW Workflow a CPW Process can be |
| | followed by one to several CPW Processes parallelly 204. |
| 6 | The complexity of a business area can be distributed on several |
| | CPW Dialogs. |
| 7 | A CPW Workflow consists of at least one CPW Dialog. |

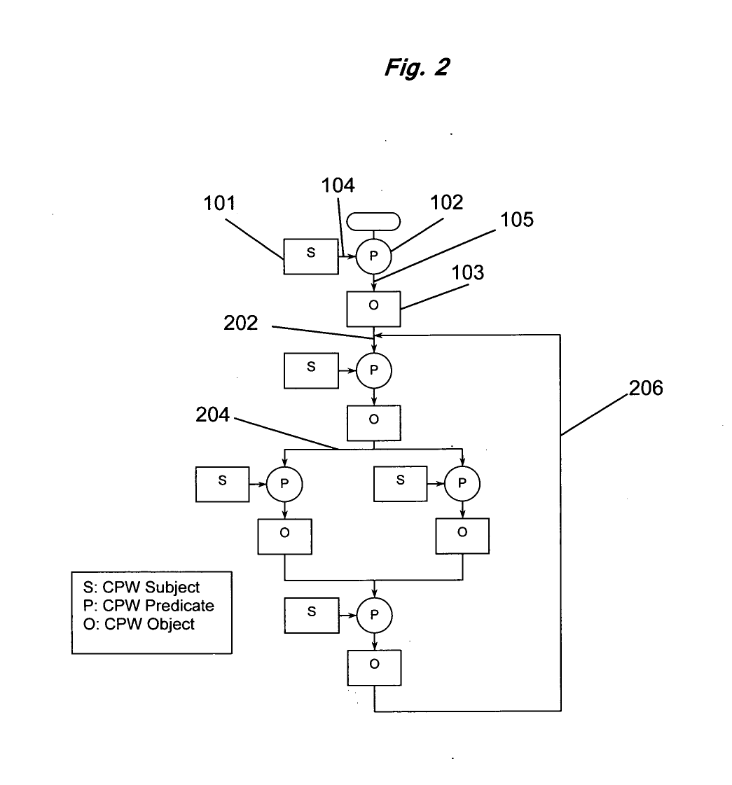

FIG. 2 shows the graphically represented CPW Processes in a CPW Dialog.

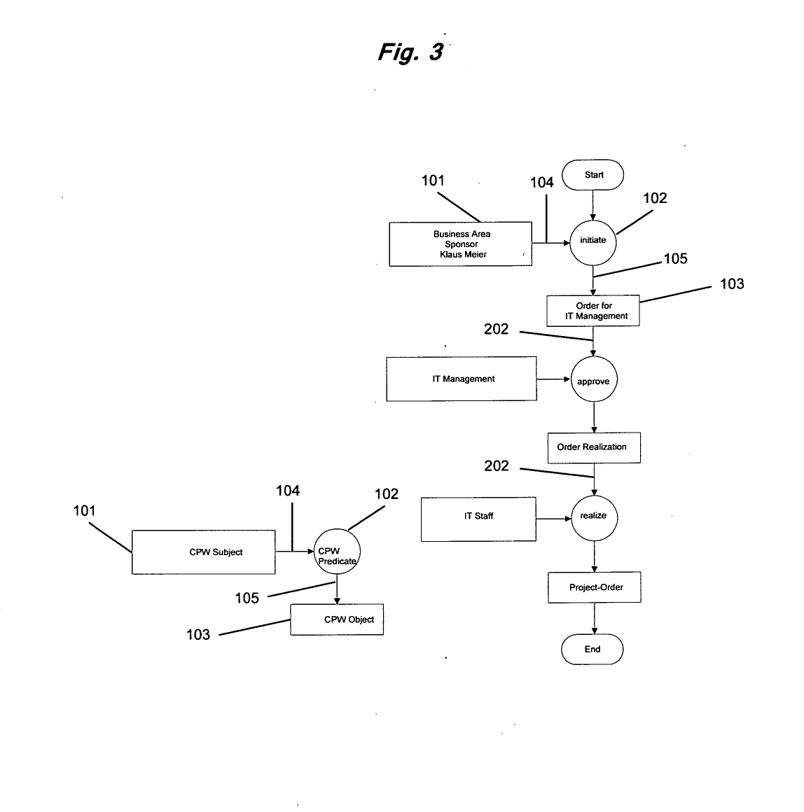

FIG. 3 shows an example of a graphically represented CPW Workflow—how IT Projects can be realized.

### Method Extensions of the CPW Process

The following list of rules shows the rules for the Grammar, Syntax and Semantics extensions of the CPW Process of the International Application No. PCT/IB2006/003133, filed Nov. 7, 2006, of the U.S. application Ser. No. 12/312,671, filed May 16, 2009.

| No. | Grammar, Syntax and Semantics extensions of the CPW Process |
|---|---|
| 1 | The CPW Process is represented in the application |
| | PCT/IB01/01337 as Simple Sentence with subject, predicate |
| | and object. |
| 2 | Subject, Predicate and Object of the CPW Process can also be |
| | named as CPW Subject, CPW Predicate and CPW Object. |
| 3 | The CPW Process defined in the application PCT/IB01/01337 is |
| | in this application a CPW Process Step, so that the CPW Process |
| | can consists of one or more CPW Process Steps. |
| 4 | The CPW Workflow can consequently also consists of one or more |
| | CPW Process Steps. |

### Method Extensions of the CPW Process, of the CPW Dialog and of the CPW Workflow

The following list of rules shows the rules for the Grammar, Syntax and Semantics extensions of the CPW Process, of the CPW Dialog and of the CPW Workflow of the International Application No. PCT/IB2006/003133, filed Nov. 7, 2006, of the U.S. application Ser. No. 12/312,671, filed May 16, 2009.

| | Grammar, Syntax and Semantics extensions of |
|---|---|
| No. | the CPW Process, of the CPW Dialog and of the CPW Workflow |
| 1 | In the application PCT/IB01/01337 the CPW Dialog has been |
| | introduced. |
| | The CPW Dialog can be interpreted as Dialog as follows: |
| | Business Dialog |
| | System Dialog |
| | Technical Dialog |
| | Dialog between Systems |
| | Dialog from machine to machine |
| | Dialog from system to system |
| | Conversation dialog between people |
| | Conversation dialog between people with interaction to system or |
| | machine |
| | Dialog between people and environment |
| | Business Process Dialog |
| | Business System Dialog |
| | Dialog in a Business Process |
| | Dialog between man and machine or system |
| | Dialog between people |
| | Dialog between man and Business System |
| | Sociocultural dialog between people |
| | Sociocultural dialog between people and systems |
| 2 | The CPW Dialog can consists of one or more CPW Process Steps. |
| 3 | The CPW Dialog can consists of one or more CPW Processes. |
| 4 | The CPW Dialog can consists of one or more CPW Workflows. |
| 5 | The CPW Dialog can contains one or more CPW Processes. |
| 6 | The CPW Dialog can contains one or more CPW Workflows. |
| 7 | The CPW Process can contains one or more CPW Dialogs. |
| 8 | The CPW Workflow can contains one or more CPW Dialogs. |
| 9 | Is the CPW Subject of the CPW Process Step of the CPW Dialog a |
| | person, or a speaking system, so the CPW Process Step with CPW |
| | Subject, CPW Predicate and CPW Object can contains the Direct |
| | Speech or Reported Speech of the dialog, it is the CPW Dialog |
| | with Direct Speech or the CPW Dialog with Reported Speech. |
| | The CPW Predicate in this case corresponds to a verb like for |
| | example: to say, to mean, to shout, to scream, to speak . . . |

### Method Extensions of the CPW Process, of the CPW Dialog and of the CPW Workflow

The following list of rules shows the rules for the Grammar, Syntax and Semantics extensions of the CPW Process, of the CPW Dialog and of the CPW Workflow.

| | Grammar, Syntax and Semantics extensions of |
|---|---|
| No. | the CPW Process, of the CPW Dialog and of the CPW Workflow |
| 1 | The CPW Process can consists of one or more CPW Workflows. |
| 2 | The CPW Process can contains one or more CPW Workflows. |

the CPW Object with CPW Sentence Complement and CPW Object Extension

The following list of rules shows the rules for the Grammar, Syntax and Semantics of the CPW Object, the CPW Sentence Complement and the CPW Object Extension according to the third and the present application.

| | Grammar, Syntax and Semantics of the CPW Object, the CPW |
|---|---|
| No. | Sentence Complement and the CPW Object Extension |
| 1 | The CPW Object is assigned a CPW Sentence Complement. |
| 2 | The CPW Object is assigned a CPW Sentence Complement and |
| | furthermore it can be assigned a CPW Object Extension. |
| 3 | The CPW Object is assigned a CPW Sentence Complement and |
| | furthermore it can be linked to the CPW Sentence Complement a |
| | CPW Object Extension. |

The CPW Object with CPW Sentence Complement

The following list of rules shows the rules for the Grammar, Syntax and Semantics of the CPW Object and the CPW Sentence Complement according to the third and the present application.

| | Grammar, Syntax and Semantics of the CPW Object and the CPW |
|---|---|
| No. | Sentence Complement |
| 1 | The CPW Sentence Complement can be assigned a grammatical |
| | Object. |
| 2 | The CPW Sentence Complement can be assigned a grammatical |
| | Complement. |
| 3 | The CPW Sentence Complement can be assigned one to several |
| | grammatical Objects. |
| 4 | The CPW Sentence Complement can be assigned one to several |
| | grammatical Complement. |
| 5 | The CPW Sentence Complement can be linked either no or one to |
| | several grammatical Objects |
| 6 | The CPW Sentence Complement can be linked either no or one to |
| | several grammatical Complements and one to several subordinate |
| | clause |
| 7 | The CPW Sentence Complement can be linked either no or one to |
| | several grammatical Objects and a direct speech |
| 8 | The CPW Sentence Complement can be linked either no or one to |
| | several grammatical Complements and a direct speech |
| 9 | The CPW Sentence Complement can be linked either no or one to |
| | several grammatical Objects and a reported speech |
| 10 | The CPW Sentence Complement can be linked either no or one to |
| | several grammatical Complements and a reported speech |

The CPW Object with CPW Object Extension

The following list of rules shows the rules for the Grammar, Syntax and Semantics of the CPW Object and the CPW Object Extension according to the third and the present application.

| | Grammar, Syntax and Semantics of the CPW Object and the CPW |
|---|---|
| No. | Object Extension |
| 1 | The CPW Object Extension can be assigned one to several numeric |
| | numbers or numeric characters. |
| 2 | The CPW Object Extension can be assigned alpha numeric |
| | characters. |
| 3 | The CPW Object Extension can be assigned one to several |
| | Hyperlinks. |
| 4 | The CPW Object Extension can be assigned a sentence. |
| 5 | The CPW Object Extension can be assigned one to several |
| | sentences. |
| 6 | The CPW Object Extension can be assigned a sentence with |
| | direct speech. |
| 7 | The CPW Object Extension can be assigned one to several |
| | sentences with direct speech. |
| 8 | The CPW Object Extension can be assigned a sentence with |
| | reported speech. |
| 9 | The CPW Object Extension can be assigned one to several |
| | sentences with reported speech. |
| 10 | The CPW Object Extension can be assigned a text. |
| 11 | The CPW Object Extension can be assigned a text or dialog with |
| | reported speech. |
| 12 | The CPW Object Extension can be assigned a text or dialog with |
| | reported direct speech. |

The CPW Object with the CPW Sentence Complement and the CPW Object Extension and the CPW Subject with the CPW Subject Complement and the CPW Subject Extension

The following list of rules shows the rules for the Grammar, Syntax and Semantics of the CPW Object with the CPW Sentence Complement and the CPW Object Extension and the CPW Subject with the CPW Subject Complement and the CPW Subject Extension according to the third and the present application.

| | Grammar, Syntax and Semantics of the CPW Object with the CPW |
|---|---|
| | Sentence Complement and the CPW Object Extension and the CPW |
| No. | Subject with the CPW Subject Complement and the CPW Subject Extension |
| 1 | The CPW Process as sentence can be formed actively or passively. |
| 2 | The active formed CPW Process is represented as Simple Sentence with a |
| | CPW Subject, a CPW Predicate and a CPW Object (with CPW Sentence |
| | Complement and with CPW Object Extension) |
| 3 | Is the active formed CPW Process formed passively, so the CPW Object |
| | becomes the CPW Subject. |
| 4 | The passive formed CPW Process is represented as Simple Sentence with a |
| | CPW Subject (a CPW Subject Complement and a CPW Subject Extension), a |
| | CPW Predicate (formed in passive) and a CPW Object. |
| 5 | From the CPW Sentence Complement of the CPW Object is formed the CPW |
| | Subject Complement of the CPW Subject. |
| 6 | From the CPW Object Extension of the CPW Object is formed the CPW |
| | Subject Extension of the CPW Subject. |
| 7 | This means, that the CPW Sentence Complement of the CPW Object from the |
| | active formed sentence of the CPW Process correspond to the CPW Subject |
| | Complement of the CPW Subject from the passive formed sentence of the |
| | CPW Process. |
| 8 | This means, that the CPW Object Extension of the CPW Object from the active |
| | formed sentence of the CPW Process correspond to the CPW Subject |
| | Extension of the CPW Subject from the passive formed sentence of the CPW |
| | Process. |
| 9 | All rules, which have been defined for the CPW Object, are also valid for the CPW |
| | Subject. |
| 10 | All rules, which have been defined for the CPW Sentence Complement, are |
| | also valid for the CPW Subject Complement. |
| 11 | All rules, which have been defined for the CPW Object Extension, are also |
| | valid for the CPW Subject Extension. |

### Die CPW Context Diagrams

### The CPW Subject Context Diagram

The following list of rules shows the rules for the Grammar, Syntax and Semantics of the CPW Subject Context Diagram of the International Application No. PCT/IB01/01337, filed Jul. 26, 2001, of the U.S. application Ser. No. 10/486,290, filed Aug. 20, 2004, and the following list of rules shows the rules for the Grammar, Syntax and Semantics of the CPW Subject Context Diagram according to the third and the present application.

| No. | Grammatik, Syntax and Semantik of the CPW Subject Context Diagram |
|---|---|
| 1 | At the creation of the CPW Subject Context Diagram there are different cases |
| | and possibilites: |
| | Case 1: Either it is created at first the CPW Process, the CPW Dialog or the |
| | CPW Workflow and then the CPW Subject Context Diagram. |
| | Case 2: Or it is created at first the CPW Subject Context Diagram and then the |
| | CPW Process, the CPW Dialog or the CPW Workflow. |
| | Case 3: Or the CPW Process, the CPW Dialog, the CPW Workflow and the |
| | CPW Subject Context Diagram are created or developed at the same time |
| | together. |
| 2 | Within a CPW Process, a CPW Dialog, a CPW Workflow each CPW Subject |
| | 101 is represented as graphic object. |
| 3 | For the to-be-executed work steps are the following rules valid: |
| | All CPW Subjects 101, which exist in the CPW Process, the CPW Dialog, the |
| | CPW Workflow, are also used in the CPW Subject Context Diagram. |
| | But not all CPW Subjects 101, which are used in the CPW Subject Context |
| | Diagram, have to be available in the CPW Process, the CPW Dialog, the CPW |
| | Workflow. |
| 4 | Within a CPW Subject Context Diagram all CPW Subjects 101 are graphically |
| | linked to one another given the fact that a connection between the respective |
| | CPW Subjects exists respectively makes sense. |
| 5 | Several CPW Subjects can be linked to one another by creating a new abstract |
| | CPW Subject 101. Thereby a hierarchy between the CPW Subjects can come into |
| | place. |

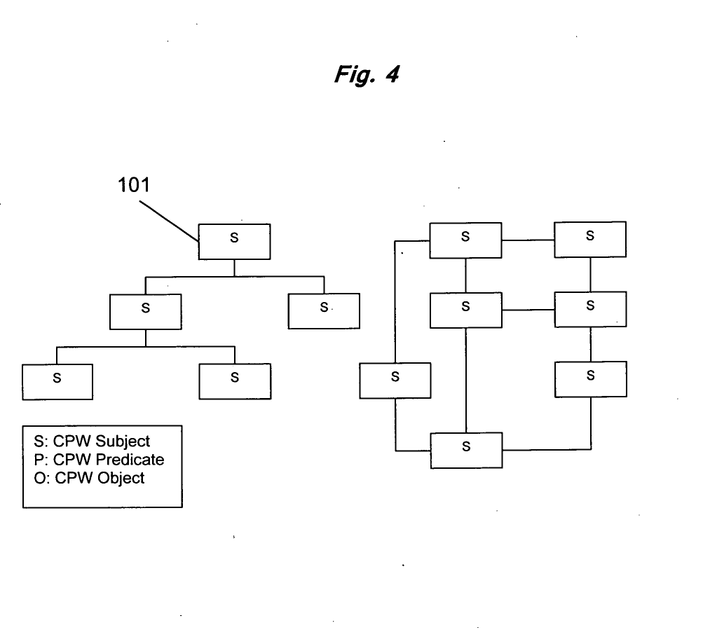

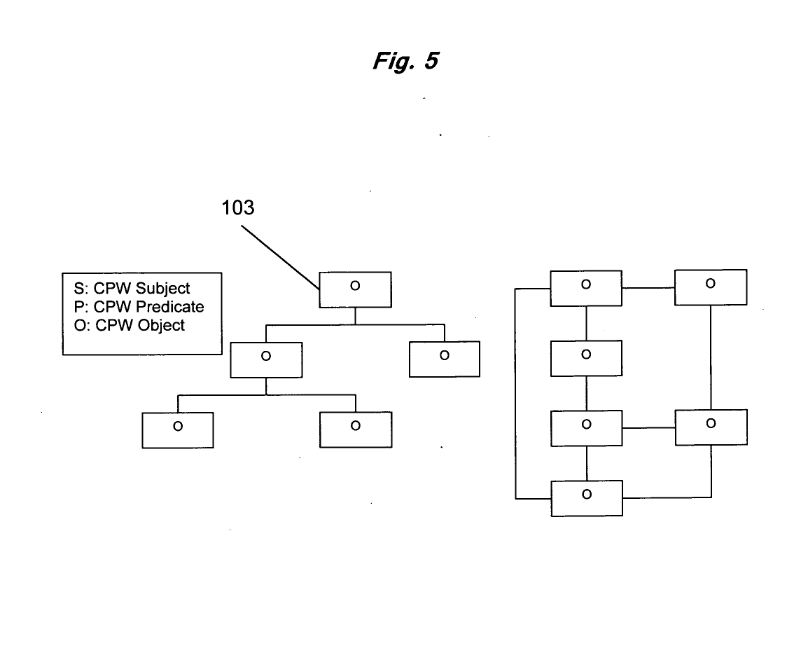

FIG. 4 shows a CPW Subject Context Diagram, which consists exclusively of CPW Subjects.

### Das CPW Object Context Diagram

The following list of rules shows the rules for the Grammar, Syntax and Semantics of the CPW Object Context Diagram of the International Application No. PCT/IB01/01337, filed Jul. 26, 2001, of the U.S. application Ser. No. 10/486,290, filed Aug. 20, 2004, and the following list of rules shows the rules for the Grammar, Syntax and Semantics of the CPW Object Context Diagram according to the third and the present application.

| No. | Grammatik, Syntax and Semantik of the CPW Object Context Diagram |
|---|---|
| 1 | At the creation of the CPW Object Context Diagram there are different cases |
| | and possibilites: |
| | Case 1: Either it is created at first the CPW Process, the CPW Dialog or the |
| | CPW Workflow and then the CPW Object Context Diagram. |
| | Case 2: Or it is created at first the CPW Object Context Diagram and then the |
| | CPW Process, the CPW Dialog or the CPW Workflow. |
| | Case 3: Or the CPW Process, the CPW Dialog, the CPW Workflow and the |
| | CPW Object Context Diagram are created or developed at the same time |
| | together. |
| 2 | Within a CPW Process, a CPW Dialog, a CPW Workflow each CPW Object |
| | 103 is represented as graphic object. |
| 3 | For the to-be-executed work steps are the following rules valid: |
| | All CPW Objects 103, which exist in the CPW Process, the CPW Dialog, the |
| | CPW Workflow, are also used in the CPW Object Context Diagram. |
| | But not all CPW Objects 103, which are used in the CPW Object Context |
| | Diagram, have to be available in the CPW Process, the CPW Dialog, the CPW |
| | Workflow. |
| 4 | Within a CPW Object Context Diagram all CPW Objects 103 are graphically |
| | linked to one another given the fact that a connection between the respective CPW |
| | Objects exists respectively makes sense. |
| 5 | Several CPW Objects can be linked to one another by creating a new abstract |
| | CPW Object 103. Thereby a hierarchy between the CPW Objects can come |
| | into place. |

FIG. 5 shows a CPW Object Context Diagram, which consists exclusively of CPW Subjects.

### Das CPW Subject Object Context Diagram

The following list of rules shows the rules for the Grammar, Syntax and Semantics of the CPW Subject Object Context Diagram of the International Application No. PCT/IB01/01337, filed Jul. 26, 2001, of the U.S. application Ser. No. 10/486,290, filed Aug. 20, 2004, and the following list of rules shows the rules for the Grammar, Syntax and Semantics of the CPW Subject Object Context Diagram according to the third and the present application.

| | Grammatik, Syntax and Semantik of the CPW Subject Object Context |
|---|---|
| No. | Diagram |
| 1 | At the creation of the CPW Subject Object Context Diagram there are different |
| | cases and possibilites: |
| | Case 1: Either it is created at first the CPW Process, the CPW Dialog or the |
| | CPW Workflow and then the CPW Subject Object Context Diagram. |
| | Case 2: Or it is created at first the CPW Subject Object Context Diagram and |
| | then the CPW Process, the CPW Dialog or the CPW Workflow. |
| | Case 3: Or the CPW Process, the CPW Dialog, the CPW Workflow and the |
| | CPW Subject Object Context Diagram are created or developed at the same |
| | time together. |
| 2 | Within a CPW Process, a CPW Dialog, a CPW Workflow each CPW Subject |
| | 101 and CPW Object 103 is represented as graphic object. |
| 3 | For the to-be-executed work steps are the following rules valid: |
| | All CPW Subjects 101 and CPW Objects 103, which exist in the CPW Process, |
| | the CPW Dialog, the CPW Workflow, are also used in the CPW Subject Object |
| | Context Diagram. |
| | But not all CPW Subjects 101 and CPW Objects 103, which are used in the |
| | CPW Subject Object Context Diagram, have to be available in the CPW |
| | Process, the CPW Dialog, the CPW Workflow. |
| 4 | Within a CPW Subject Object Context Diagram all CPW Subjects 101 and CPW |
| | Objects 103 are graphically linked to one another given the fact that a connection |
| | between the respective CPW Subjects and CPW Objects exists respectively |
| | makes sense. |
| 5 | Several CPW Subjects and CPW Objects can be linked to one another by |
| | creating a new abstract CPW Subject 101 or CPW Object 103. Thereby a |
| | hierarchy between the CPW Subjects and CPW Objects can come into place. |

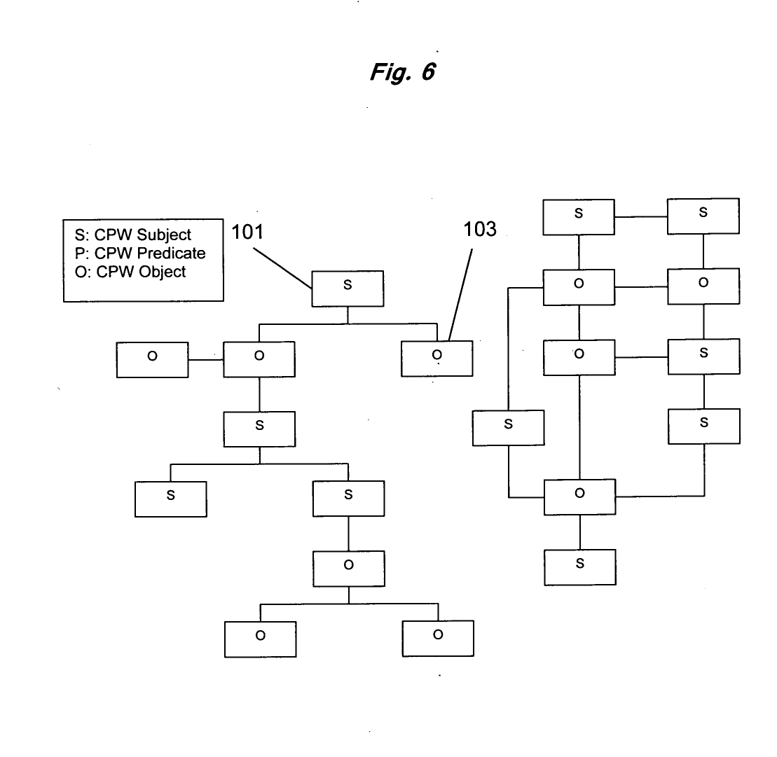

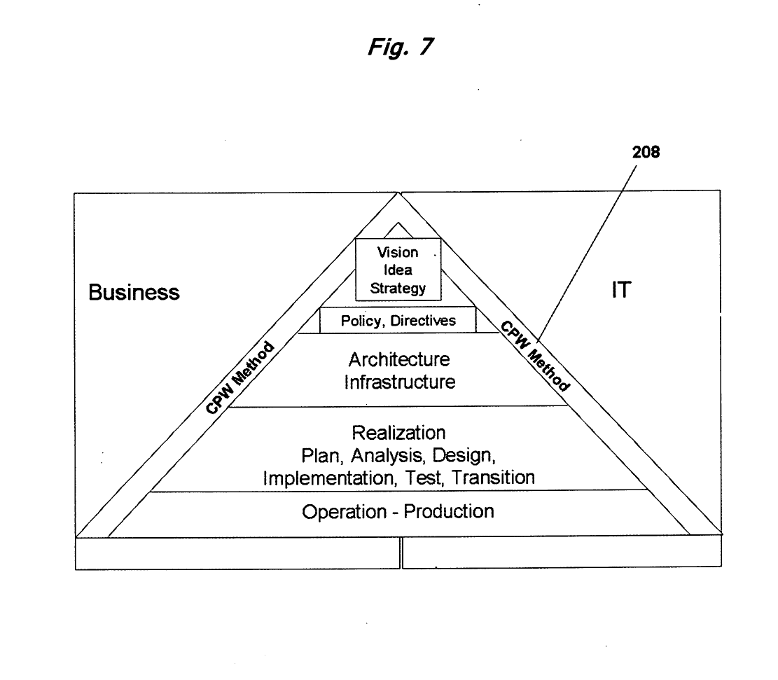

FIG. 6 shows a CPW Subject Object Context Diagram, which consists exclusively of CPW Subjects and CPW Objects.

### CPW Method Applied on Various Levels

The CPW Method can be applied on various Levels:
1. Vision, idea, strategy
2. Policy, directives
3. Architecture, infrastructure
4. Realization (Plan, Analysis, Design, Implementation, Test, Transition)
5. Operation, Production

In FIG. 7 is represented in a diagram, on which various Levels and in which diverse areas the CPW Method 208 can be applied in Business and IT.

| | Key terms and definitions |
|---|---|
| No. | (Schlüsselbegriffe und Definitionen) |
| 1 | extensions |
| 2 | rules |
| 3 | grammar |
| 4 | syntax |
| 5 | semantics |
| 6 | CPW Method |
| 7 | CPW Process |
| 8 | CPW Dialog |
| 9 | CPW Workflow |
| 10 | simple sentence |
| 11 | phrases |
| 12 | aktive |
| 13 | passive |
| 14 | CPW Subject |
| 15 | CPW Predicate |
| 16 | CPW Object |
| 17 | responsibility |
| 18 | process result |
| 19 | subject |
| 20 | predicate |
| 21 | object |
| 22 | CPW Sentence Complement |
| 23 | CPW Object Extension |
| 24 | CPW Subject Complement |
| 25 | CPW Subject Extension |
| 26 | grammatical object |
| 27 | grammatical complement |
| 28 | sentence |
| 29 | subordinate clause |
| 30 | direct speech |
| 31 | reported speech |
| 32 | dialog, dialogue |
| 33 | text |
| 34 | numeric numbers |
| 35 | numeric characters |
| 36 | alpha-numeric characters |
| 37 | Hyperlinks |
| 38 | CPW Context Diagram |
| 39 | CPW Subject Context Diagram |
| 40 | CPW Object Context Diagram |
| 41 | CPW Subject Object Context Diagram |
| 42 | graphical object |

### 9 DICTIONARY

Terms for the CPW Method, Extensions of the CPW Method and CPW Method Component

| No. | English | German |
|---|---|---|
| 1 | Cognitive Process Workflow (CPW) | Kognitive Prozess Workflow (CPW) |
| | Method | Methode |
| 2 | CPW Method | CPW Methode |
| 3 | CPW Process | CPW Prozess |
| 4 | CPW Dialog | CPW Dialog |
| 5 | CPW Workflow | CPW Workflow |
| 6 | CPW Subject | CPW Subjekt |
| 7 | CPW Predicate | CPW Prädikat |
| 8 | CPW Object | CPW Objekt |
| 9 | CPW Sentence Complement | CPW Satzergänzung |
| 10 | CPW Object Extension | CPW Objekt Erweiterung |
| 11 | CPW Subject Complement | CPW Subjekt Ergänzung |
| 12 | CPW Subject Extension | CPW Subjekt Erweiterung |
| 13 | CPW Context Diagram | CPW Kontext Diagramme |
| 14 | CPW Subject Context Diagram | CPW Subjekt Kontext Diagramm |
| 15 | CPW Object Context Diagram | CPW Objekt Kontext Diagramm |
| 16 | CPW Subject Object Context | CPW Subjekt Objekt Kontext Diagramm |
| | Diagram | |
| 17 | CPW Enterprise Architecture | CPW Enterprise Architektur Framework |
| | Framework | |
| 18 | CPW Enterprise Architecture Engine | CPW Enterprise Architektur Engine |
| 19 | extensions | Erweiterungen |
| 20 | rules | Regeln |
| 21 | grammar | Gramatik |
| 22 | syntax | Syntax |
| 23 | semantics | Semantik |
| 24 | simple sentence | einfacher Satz |
| 25 | phrases | Satzglieder |
| 26 | subject | Subjekt |
| 27 | predicate | Prädikat |
| 28 | object | Objekt |
| 29 | active | aktiv |
| 30 | passive | passiv |
| 31 | responsibility | Verantwortlichkeit |
| 32 | process result | Prozess Ergebnis, Prozessergebnis |
| 33 | sentence | Satz |
| 34 | grammatical object | grammatikalisches Objekt |
| 35 | grammatical complement | grammatikalisches Ergänzung |
| 36 | subordinate clause | Nebensätze |
| 37 | direct speech | direkte Rede |
| 38 | reported speech | indirekte Rede |
| 39 | dialog, dialogue | Diàlog |
| 40 | text | Text |
| 41 | graphical object | grafisches Objekt |
| 42 | numeric numbers | numerische Zahlen |
| 43 | numeric characters | numerische Zeichen |
| 44 | alpha-numeric characters | alphanumerische Zeichen |
| 45 | Hyperlinks | Hyperlinks |
| 46 | Process Method | Prozess Methode |
| 47 | Process Methods | Prozess Methoden |
| 48 | Process Modeling Method | Prozess Modelierungs Methode |
| 49 | Process Modeling Methods | Prozess Modelierungs Methoden |
| 50 | Workflow Method | Workflow Methode |
| 51 | Workflow Methods | Workflow Methoden |
| 52 | Process | Prozess |
| 53 | Process Step | Prozess Schritt |
| 54 | Workflow Step | Workflow Schritt |
| 55 | Bubble | Bubble, Blase |
| 56 | Context Diagrams | Kontext Diagramme |
| 57 | Levels | Ebenen |
| 58 | Business Dialog | Business Dialog |
| 59 | Dialog | Dialog |
| 60 | Business Process | Business Prozess |
| 61 | Business Process Dialog | Business Prozess Dialog |
| 62 | Business System Dialog | Business System Dialog |
| 63 | Business System | Business System |
| 64 | application system | Applikations System |
| 65 | technical system | technischen System |
| 66 | Business Tool | Business Tool |
| 67 | IT Tool | IT Tool |
| 68 | IT Development Tool | IT Entwicklungs Tool |
| 69 | IT System | IT System |
| 70 | Process Tools | Prozess Tools |
| 71 | Workflow Tools | Workflow Tools |
| 72 | Workflow Engine | Workflow Engine |
| 73 | Enterprise Architecture Framework | Enterprise Architektur Framework |
| 74 | Enterprise Architecture Engine | Enterprise Architektur Engine |
| 75 | Vision | Vision |
| 76 | Strategy | Strategie |
| 77 | Idea | Idee |
| 78 | Policy | Policy |
| 79 | Guideline | Richtlinien |
| 80 | Architecture | Achitektur |
| 81 | Infrastructure | Infrastruktur |
| 82 | Realization | Realisierung |
| 83 | Plan | Plan |
| 84 | Analysis | Analyse |
| 85 | Design | Design |
| 86 | Implementation | Implementierung |
| 87 | Test | Test |
| 88 | Transition | Einführung |
| 89 | Operation | Operation |
| 90 | Production | Produktion |
| 91 | Business, Business Area | Business, Geschäftsbereich |
| 92 | Business Areas | Geschäftsbereiche |
| 93 | Financial Services | Finanzdienstleistungen |
| 94 | Banking | Bankwesen |
| 95 | Assurance | Versicherungwesen |
| 96 | Financial Approval | Wirtschaftsprüfung |
| 97 | Chemistry | Chemie |
| 98 | Pharmacy | Pharmazie |
| 99 | Medicine | Medizin |
| 100 | Transport | Transportwesen, Frachtwesen und |
| | | Verkehrswesen |
| 101 | Travel | Reisewesen |
| 102 | Film Industry | Filmindustrie |
| 103 | Politics | Politik |
| 104 | Psychology | Psychologie |
| 105 | Legal Practice, Jurisprudence, | Jura, Rechtswissenschaft und |
| | Judiciary | Rechtswesen |

### 9.1 Further Terms

| No. | English | German |
|---|---|---|
| 1 | US Application No. | US Aktenzeichen |
| 2 | Filing Date | Anmeldedatum |
| 3 | Figure | Abbildung |
| 4 | Fig. (figure) | Abb. (Abbildung) |
| 5 | No., no. (number) | Nr. (Nummer) |
| 6 | Key criteria | Key Kriterien, Schlüsselkriterien |
| 7 | Key terms | Schlüsselbegriffe |
| 8 | definitions | Definitionen |

1. A method for process modeling, which is the said Cognitive Process Workflow (CPW) Method with the following said rules for the Grammar, Syntax and Semantics of the said CPW Process, comprising:
wherein the said CPW Process is represented as Simple Sentence with a CPW Subject, a CPW Predicate and a CPW Object; and
wherein the said CPW Process in the form of a Simple Sentence consists of the following phrases: a CPW Subject: Description of the subject (person, organizational unit or thing), a CPW Predicate: Description of the process (verb in the infinitive or conjugated), a CPW Object: Description of the object (a CPW Sentence Complement and a CPW Object Extension); and
wherein the said CPW Process in the form of a sentence can be formed actively or passively; and
according to the said CPW Process definition the process in the conventional sense is a CPW Predicate; and from now on the conventional process (CPW Predicate) is consequently put in the context of a responsibility (a CPW Subject) and a process result (a CPW Object), thus forming a said CPW Process.

2. A method according to claim 1, which is the said Cognitive Process Workflow (CPW) Method with the following said rules for the Grammar, Syntax and Semantics of the said CPW Object, the said CPW Sentence Complement and the said CPW Object Extension, further comprising:
wherein the said CPW Object is assigned a said CPW Sentence Complement; and
wherein the said CPW Object is assigned a said CPW Sentence Complement and furthermore it can be assigned a said CPW Object Extension; and
wherein the said CPW Object is assigned a said CPW Sentence Complement and furthermore it can be linked to the said CPW Sentence Complement a said CPW Object Extension; and
wherein the said CPW Sentence Complement can be assigned a grammatical Object; and
wherein the said CPW Sentence Complement can be assigned a grammatical Complement; and
wherein the said CPW Sentence Complement can be assigned one to several grammatical Objects; and
wherein the said CPW Sentence Complement can be assigned one to several grammatical Complement; and
wherein the said CPW Sentence Complement can be linked either no or one to several grammatical Objects; and
wherein the said CPW Sentence Complement can be linked either no or one to several grammatical Complements and one to several subordinate clause; and
wherein the said CPW Sentence Complement can be linked either no or one to several grammatical Objects and a direct speech; and
wherein the said CPW Sentence Complement can be linked either no or one to several grammatical Complements and a direct speech; and
wherein the said CPW Sentence Complement can be linked either no or one to several grammatical Objects and a reported speech; and
wherein the said CPW Sentence Complement can be linked either no or one to several grammatical Complements and a reported speech.

3. A method according to claim 2, which is the said Cognitive Process Workflow (CPW) Method with the following said rules for the Grammar, Syntax and Semantics of the said CPW Object, the said CPW Sentence Complement and the said CPW Object Extension, further comprising:
wherein the said CPW Object is assigned a said CPW Sentence Complement; and
wherein the said CPW Object is assigned a said CPW Sentence Complement and furthermore it can be assigned a said CPW Object Extension; and
wherein the said CPW Object is assigned a said CPW Sentence Complement and furthermore it can be linked to the said CPW Sentence Complement a said CPW Object Extension; and
wherein the said CPW Object Extension can be assigned one to several numeric numbers or numeric characters; and
wherein the said CPW Object Extension can be assigned alpha numeric characters; and
wherein the said CPW Object Extension can be assigned one to several Hyperlinks; and
wherein the said CPW Object Extension can be assigned a sentence; and
wherein the said CPW Object Extension can be assigned one to several sentences; and
wherein the said CPW Object Extension can be assigned a sentence with direct speech; and
wherein the said CPW Object Extension can be assigned one to several sentences with direct speech; and
wherein the said CPW Object Extension can be assigned a sentence with reported speech; and
wherein the said CPW Object Extension can be assigned one to several sentences with reported speech; and
wherein the said CPW Object Extension can be assigned a text; and
wherein the said CPW Object Extension can be assigned a text or dialog with reported speech; and
wherein the said CPW Object Extension can be assigned a text or dialog with reported direct speech.

4. A method according to claim 3, which is the said Cognitive Process Workflow (CPW) Method with the following said rules for the Grammar, Syntax and Semantics of the said CPW Object, the said CPW Sentence Complement and the said CPW Object Extension, and the said CPW Subject with the said CPW Subject Complement and the said CPW Subject Extension, further comprising:
wherein the said CPW Process as sentence can be formed actively or passively; and
wherein the said active formed CPW Process is represented as Simple Sentence with a said CPW Subject, a said CPW Predicate and a said CPW Object (with said CPW Sentence Complement and with said CPW Object Extension); and
is the active formed said CPW Process formed passively, so the said CPW Object becomes the CPW Subject; and
wherein the said passive formed CPW Process is represented as Simple Sentence with a said CPW Subject (a said CPW Subject Complement and a said CPW Subject Extension), a said CPW Predicate (formed in passive) and a said CPW Object; and
wherein from said CPW Sentence Complement of the said CPW Object is formed the said CPW Subject Complement of the said CPW Subject; and
wherein from said CPW Object Extension of the said CPW Object is formed the said CPW Subject Extension of the said CPW Subject; and
this means, that the said CPW Sentence Complement of the said CPW Object from the active formed sentence of the said CPW Process correspond to the said CPW Subject Complement of the said CPW Subject from the passive formed sentence of the said CPW Process; and
this means, that the said CPW Object Extension of the said CPW Object from the active formed sentence of the said CPW Process correspond to the said CPW Subject Extension of the said CPW Subject from the passive formed sentence of the said CPW Process; and
wherein all rules, which have been defined for the said CPW Object, are also valid for the said CPW Subject; and
wherein all rules, which have been defined for the said CPW Sentence Complement, are also valid for the said CPW Subject Complement; and
wherein all rules, which have been defined for the said CPW Object Extension, are also valid for the said CPW Subject Extension.

5. A method according to claim 4, wherein the said CPW Method with the said CPW Process can be applied in all kinds of applications in technical systems; and
wherein the said CPW Method can be applied in different business areas.

6. A method according to claim 5, wherein the said CPW Method with the said CPW Process as a process method, a process modeling method and a workflow method can be applied in all kinds of applications in technical systems; and
wherein the said CPW Method can be applied in different business areas: Financial Services (Banking, Assurance and Financial Approval), Chemistry, Pharmacy, Medicine, Transport and Travel, Film Industry, Politics, Psychology, Legal Practice, Jurisprudence, Judiciary.

7. A method according to claim 4, which is the said Cognitive Process Workflow (CPW) Method with the following said rules for the Grammar, Syntax and Semantics for the graphical representation of the said CPW Process, further comprising:
wherein the said CPW Process is graphically represented as Simple Sentence with a CPW Subject, a CPW Predicate and a CPW Object; and
wherein within a represented CPW Process respectively within a sentence the CPW Subject, the CPW Predicate and the CPW Object each corresponds with a graphic object; and
the CPW Subject, the CPW Predicate and the CPW Object, each represented as a single graphic object, are graphically linked to one another with arrows, so that they form a Simple Sentence respectively a CPW Process.

8. A method according to claim 7, wherein the said CPW Method with the said CPW Process can be applied in all kinds of applications in technical systems; and
wherein the said CPW Method can be applied in different business areas.

9. A method according to claim 8, wherein the said CPW Method with the said CPW Process as a process method, a process modeling method and a workflow method can be applied in all kinds of applications in technical systems; and
wherein the said CPW Method can be applied in different business areas: Financial Services (Banking, Assurance and Financial Approval), Chemistry, Pharmacy, Medicine, Transport and Travel, Film Industry, Politics, Psychology, Legal Practice, Jurisprudence, Judiciary.

10. A method according to claim 4, which is the said Cognitive Process Workflow (CPW) Method with the following said rules for the Grammar, Syntax and Semantics of the said CPW Process, of the said CPW Dialog, and of the said CPW Workflow, further comprising:
wherein the said CPW Dialog consists of several Simple Sentences respectively said CPW Processes which are linked to one another; and
wherein Several sentences respectively said CPW Processes can be linked sequentially, logically, iteratively or parallely to a said CPW Dialog; and
the Complexity of a business area can be distributed on several said CPW Dialogs; and
a said CPW Workflow consists of at least one said CPW Dialog.

11. A method according to claim 10, wherein the said CPW Method with the said CPW Process, said CPW Dialog, and said CPW Workflow can be applied in all kinds of applications in technical systems; and
wherein the said CPW Method can be applied in different business areas.

12. A method according to claim 10 or claim 7, which is the said Cognitive Process Workflow (CPW) Method with the following said rules for the Grammar, Syntax and Semantics for the graphical representation of the said CPW Process, of the said CPW Dialog, and of the said CPW Workflow, further comprising:
wherein several said CPW Processes linked to one another form a said CPW Dialog or a said CPW Workflow; and
wherein the said CPW Processes can be linked sequentially to a said CPW Dialog or a said CPW Workflow; and
after a said CPW Process there can be a logical operation due to a decision within a said CPW Dialog or said CPW Workflow; and
within a said CPW Dialog or said CPW Workflow there can be an iteration; and
within a said CPW Dialog or said CPW Workflow a said CPW Process can be followed by one to several said CPW Processes parallelly; and
the complexity of a business area can be distributed on several said CPW Dialogs; and
a said CPW Workflow consists of at least one said CPW Dialog.

13. A method according to claim 12, which is the said Cognitive Process Workflow (CPW) Method with the following said rules for the Grammar, Syntax and Semantics for the graphical representation of the said CPW Process, of the said CPW Dialog, and of the said CPW Workflow, further comprising:
wherein the said CPW Dialog can consists of one or more said CPW Process Steps; and
wherein the said CPW Dialog can consists of one or more said CPW Processes; and
wherein the said CPW Dialog can consists of one or more said CPW Workflows; and
wherein the said CPW Dialog can contains one or more said CPW Processes; and
wherein the said CPW Dialog can contains one or more said CPW Workflows; and
wherein the said CPW Process can contains one or more said CPW Dialogs; and
wherein the said CPW Workflow can contains one or more said CPW Dialogs; and
wherein the said CPW Dialog can contains the Direct Speech or Reported Speech of the dialog, it is the said CPW Dialog with Direct Speech or the said CPW Dialog with Reported Speech; and
wherein the said CPW Process can consists of one or more said CPW Workflows; and
wherein the said CPW Process can contains one or more said CPW Workflows.

14. A method according to claim 7, wherein the said CPW Method with the said CPW Process, said CPW Dialog and said CPW Workflow can be applied in all kinds of applications in technical systems; and
wherein the said CPW Method can be applied in different business areas.

15. A method according to claim 13, which is the said Cognitive Process Workflow (CPW) Method with the following said rules for the Grammar, Syntax and Semantics of the said CPW Subject Context Diagram, further comprising:
wherein at the creation of the said CPW Subject Context Diagram there are different cases and possibilites:
case 1: either it is created at first the said CPW Process, the said CPW Dialog or the said CPW Workflow and then the said CPW Subject Context Diagram,
case 2: or it is created at first the said CPW Subject Context Diagram and then the said CPW Process, the said CPW Dialog or the said CPW Workflow,
case 3: or the said CPW Process, the said CPW Dialog, the said CPW Workflow and the said CPW Subject Context Diagram are created or developed at the same time together; and
wherein within a said CPW Process, a said CPW Dialog, a said CPW Workflow each said CPW Subject is represented as graphic object; and
wherein for the to-be-executed work steps are the following rules valid:
all said CPW Subjects, which exist in the said CPW Process, the said CPW Dialog, the said CPW Workflow, are also used in the said CPW Subject Context Diagram;
but not all said CPW Subjects, which are used in the said CPW Subject Context Diagram, have to be available in the said CPW Process, the said CPW Dialog, the said CPW Workflow; and
wherein within a said CPW Subject Context Diagram all said CPW Subjects are graphically linked to one another given the fact that a connection between the respective said CPW Subjects exists respectively makes sense; and
several said CPW Subjects can be linked to one another by creating a new abstract said CPW Subject;
and thereby a hierarchy between the said CPW Subjects can come into place.

16. A method according to claim 15, wherein the said CPW Method with the said CPW Subject Context Diagram can be applied in all kinds of applications in technical systems; and
wherein the said CPW Method can be applied in different business areas.

17. A method according to claim 15, which is the said Cognitive Process Workflow (CPW) Method with the following said rules for the Grammar, Syntax and Semantics of the said CPW Object Context Diagram, further comprising:
wherein at the creation of the said CPW Object Context Diagram there are different cases and possibilites:
case 1: either it is created at first the said CPW Process, the said CPW Dialog or the said CPW Workflow and then the said CPW Object Context Diagram,
case 2: or it is created at first the said CPW Object Context Diagram and then the said CPW Process, the said CPW Dialog or the said CPW Workflow,
case 3: or the said CPW Process, the said CPW Dialog, the said CPW Workflow and the said CPW Object Context Diagram are created or developed at the same time together; and
wherein within a said CPW Process, a said CPW Dialog, a said CPW Workflow each said CPW Object is represented as graphic object; and
wherein for the to-be-executed work steps are the following rules valid:
all said CPW Objects, which exist in the said CPW Process, the said CPW Dialog, the said CPW Workflow, are also used in the said CPW Object Context Diagram;
but not all said CPW Object, which are used in the said CPW Object Context Diagram, have to be available in the said CPW Process, the said CPW Dialog, the said CPW Workflow; and
wherein within a said CPW Object Context Diagram all said CPW Objects are graphically linked to one another given the fact that a connection between the respective said CPW Objects exists respectively makes sense; and
several said CPW Objects can be linked to one another by creating a new abstract said CPW Object;
and thereby a hierarchy between the said CPW Objects can come into place.

18. A method according to claim 17, wherein the said CPW Method with the said CPW Object Context Diagram can be applied in all kinds of applications in technical systems; and
wherein the said CPW Method can be applied in different business areas.

19. A method according to claim 17, which is the said Cognitive Process Workflow (CPW) Method with the following said rules for the Grammar, Syntax and Semantics of the said CPW Subject Object Context Diagram, further comprising:
wherein at the creation of the said CPW Subject Object Context Diagram there are different cases and possibilites:
case 1: either it is created at first the said CPW Process, the said CPW Dialog or the said CPW Workflow and then the said CPW Subject Object Context Diagram,
case 2: or it is created at first the said CPW Subject Object Context Diagram and then the said CPW Process, the said CPW Dialog or the said CPW Workflow,
case 3: or the said CPW Process, the said CPW Dialog, the said CPW Workflow and the said CPW Subject Object Context Diagram are created or developed at the same time together; and
wherein within a said CPW Process, a said CPW Dialog, a said CPW Workflow each said CPW Subject and said CPW Object is represented as graphic object; and
wherein for the to-be-executed work steps are the following rules valid:
all said CPW Subjects and said CPW Objects, which exist in the said CPW Process, the said CPW Dialog, the said CPW Workflow, are also used in the said CPW Subject Object Context Diagram;
but not all said CPW Subjects and said CPW Objects, which are used in the said CPW Subject Object Context Diagram, have to be available in the said CPW Process, the said CPW Dialog, the said CPW Workflow; and
wherein within a said CPW Subject Object Context Diagram all said CPW Subjects and said CPW Objects are graphically linked to one another given the fact that a connection between the respective said CPW Subjects and said CPW Objects exists respectively makes sense; and
several said CPW Subjects and CPW Objects can be linked to one another by creating a new abstract said CPW Subject or said CPW Object;
and thereby a hierarchy between the said CPW Subjects and said CPW Objects can come into place.

20. A method according to claim 19, wherein the said CPW Method with the said CPW Subject Object Context Diagram can be applied in all kinds of applications in technical systems; and
wherein the said CPW Method can be applied in different business areas.

21. A method according to claim 19, further comprising, wherein the said CPW Method is with the said CPW Process, the said CPW Dialog and the said CPW Workflow a process method, a process modeling method and a workflow method and in addition belong to the said CPW Method the said CPW Context Diagrams with the said CPW Subject Context Diagram, the said CPW Object Context Diagram and the said CPW Subject Object Context Diagram.

22. A method according to claim 13, further comprising, wherein the said CPW Method is with the said CPW Process, the said CPW Dialog and the said CPW Workflow a process method, a process modeling method and a workflow method.

23. A method for process modeling applicable in a system, comprising, wherein the said Cognitive Process Workflow (CPW) Method can be applied in all kinds of applications in technical systems, and:
wherein the application of the said CPW Method is in a Workflow Engine and a Workflow Tool;
and wherein the application of the graphical representation of the said CPW Method is in a technical system;
and wherein the application of the said CPW Method is in an application system with integrated database;
and wherein the application of the said CPW Method is in a Process Tool;
and wherein the application of the said CPW Method is in a business tool, IT Tool, IT Development Tool, IT System;
and wherein the application of the said CPW Method is by means of Internet technologies;
and wherein the application of the said CPW Method is in an application system.

24. A system for process modeling, comprising, wherein the said Cognitive Process Workflow (CPW) Method can be applied in all kinds of applications in technical systems, and:
wherein the application of the said CPW Method is in a Workflow Engine and a Workflow Tool;
and wherein the application of the graphical representation of the said CPW Method is in a technical system;
and wherein the application of the said CPW Method is in an application system with integrated database;
and wherein the application of the said CPW Method is in a Process Tool;
and wherein the application of the said CPW Method is in a business tool, IT Tool, IT Development Tool, IT System;
and wherein the application of the said CPW Method is by means of Internet technologies;
and wherein the application of the said CPW Method is in an application system.

25. A computer program product for process modeling, comprising, wherein the said Cognitive Process Workflow (CPW) Method can be applied in all kinds of applications in technical systems, and:
wherein the application of the said CPW Method is in a Workflow Engine and a Workflow Tool;
and wherein the application of the graphical representation of the said CPW Method is in a technical system;
and wherein the application of the said CPW Method is in an application system with integrated database;
and wherein the application of the said CPW Method is in a Process Tool;
and wherein the application of the said CPW Method is in a business tool, IT Tool, IT Development Tool, IT System;
and wherein the application of the said CPW Method is by means of Internet technologies;
and wherein the application of the said CPW Method is in an application system.

26. A method for process modeling applicable in a system, comprising, wherein the said Cognitive Process Workflow (CPW) Method can be applied in all kinds of applications in technical systems, and:
wherein the application of the said CPW Method is in a Workflow Engine and a Workflow Tool;
and wherein the application of the graphical representation of the said CPW Method is in a technical system;
and wherein the application of the said CPW Method is in a Process Tool;
and wherein the application of the said CPW Method is in a business tool, IT Tool, IT Development Tool, IT System;
and wherein the application of the said CPW Method is by means of Internet technologies;
and wherein the application of the said CPW Method is in an application system;
and wherein the application of the said CPW Method is in an Enterprise Architecture Framework and an Enterprise Architecture Engine;
and wherein the application of the said CPW Method is in an CPW Enterprise Architecture Framework and an CPW Enterprise Architecture Engine;
and wherein the application of the said CPW Method is by means of XML, XML Process Definition Language (XPDL), Web Services (WS), Business Process Modeling Notation (BPMN), Business Process Execution Language (BPEL), Web Services Definition Language (WSDL), Flow Definition Language (FDL) and other technical methods and protocols.

27. A system for process modeling, comprising, wherein the said Cognitive Process Workflow (CPW) Method can be applied in all kinds of applications in technical systems, and:
wherein the application of the said CPW Method is in a Workflow Engine and a Workflow Tool;
and wherein the application of the graphical representation of the said CPW Method is in a technical system;
and wherein the application of the said CPW Method is in a Process Tool;
and wherein the application of the said CPW Method is in a business tool, IT Tool, IT Development Tool, IT System;
and wherein the application of the said CPW Method is by means of Internet technologies;
and wherein the application of the said CPW Method is in an application system;
and wherein the application of the said CPW Method is in an Enterprise Architecture Framework and an Enterprise Architecture Engine;
and wherein the application of the said CPW Method is in an CPW Enterprise Architecture Framework and an CPW Enterprise Architecture Engine;
and wherein the application of the said CPW Method is by means of XML, XML Process Definition Language (XPDL), Web Services (WS), Business Process Modeling Notation (BPMN), Business Process Execution Language (BPEL), Web Services Definition Language (WSDL), Flow Definition Language (FDL) and other technical methods and protocols.

28. A computer program product for process modeling, comprising, wherein the said Cognitive Process Workflow (CPW) Method can be applied in all kinds of applications in technical systems, and:
wherein the application of the said CPW Method is in a Workflow Engine and a Workflow Tool;
and wherein the application of the graphical representation of the said CPW Method is in a technical system;
and wherein the application of the said CPW Method is in a Process Tool;
and wherein the application of the said CPW Method is in a business tool, IT Tool, IT Development Tool, IT System;
and wherein the application of the said CPW Method is by means of Internet technologies;
and wherein the application of the said CPW Method is in an application system;
and wherein the application of the said CPW Method is in an Enterprise Architecture Framework and an Enterprise Architecture Engine;
and wherein the application of the said CPW Method is in an CPW Enterprise Architecture Framework and an CPW Enterprise Architecture Engine;
and wherein the application of the said CPW Method is by means of XML, XML Process Definition Language (XPDL), Web Services (WS), Business Process Modeling Notation (BPMN), Business Process Execution Language (BPEL), Web Services Definition Language (WSDL), Flow Definition Language (FDL) and other technical methods and protocols.
